(19) United States
(12) Patent Application Publication
(10) Pub. No.: US 2020/0327632 A1
(43) Pub. Date: Oct. 15, 2020

(54) METHOD AND SYSTEM TO ENFORCE TRAFFIC LAWS USING COMMON CITIZENS

(71) Applicant: EMMANOEL FRANCISCO LAVAGNOLLI TAVARES, Fremont, CA (US)

(72) Inventor: EMMANOEL FRANCISCO LAVAGNOLLI TAVARES, Fremont, CA (US)

(21) Appl. No.: 16/847,600

(22) Filed: Apr. 13, 2020

Related U.S. Application Data
(60) Provisional application No. 62/833,666, filed on Apr. 13, 2019.

(51) Int. Cl. G06Q 50/26; G08G 1/054; G06Q 10/10; G06N 20/00; G06N 5/04; H04N 5/76

(52) U.S. Cl. CPC G06Q 50/265; G08G 1/054; H04N 5/76; G06N 20/00; G06N 5/04; G06Q 10/10

(57) ABSTRACT

The present invention comprises a method and a system for identifying and registering a traffic violation using the common citizen as an agent.

In some embodiments, a common citizen installs a camera in the dashboard of his car. The camera records in continuous mode. When a traffic violation occurs in sight of the citizen, he commands the camera to preserve that occurrence. The camera automatically saves a video file that starts 2 minutes before the command was given and ends 2 minutes after the command was given. This 2 minutes time interval can be adjusted by the user. The recorded video constitutes the proof of a violation occurrence. This information is transmitted to a processing unit, validated and a citation or notice of citation is issued.

### BACKGROUND

### 1) Field of the Invention

This invention relates generally to a method and system for identifying and registering the occurrence of traffic violations.

### 2) Background

Traffic laws regulate the proper use of vehicles on the road and keep traffic flowing in an orderly manner. Traffic enforcement is necessary to maintain compliance with the laws and reduce the risk of accidents.

Traditionally, police officers enforce traffic laws. The method consists in 1) allocating a police officer at specific locations at specific times where they wait for the occurrence of traffic violations. 2) Once a traffic violation occurs, the police officer intercepts the transgressor and 3) a ticket is issued. The use of police officers is expensive as it requires traffic enforcement agencies to invest in proper training and equipment. It also distracts police officers' focus from their main function which is to protect the community from crimes. It is also time inefficient.

More recently, Automated Enforcement Systems (AES) have being used for traffic enforcement. These systems comprise of 1) Sensors installed at intersections to automatically detect vehicles running red lights (red light cameras) or of electronic apparatuses that measure the speed of passing vehicles (speed traps) and 2) when a transgressor is detected, a video is saved and 3) information is processed and 4) a ticket or notice of violation is issued.

The cost associated using either police officers or Automated Enforcement Systems makes it impractical to enforce traffic laws at all traffic ways and at all times.

Traffic violations occur when police officers or where AES are not present. There is a lack of punishment when these violations are not recorded and a corresponding citation is not issued. This also represents loss of revenue for the traffic enforcement authority. Lack of enforcement let careless and negligent drivers go unpunished which is not fair for the conscientious and law abiding drivers.

To increase enforcement by expanding the presence of police officers on the road is not cost effective as most areas do not generate enough revenue from fines to cover the investment in labor and equipment.

Automated Enforcement Systems (AES) are expensive, controversial and have limited efficacy. AES are limited to being deployed at one location and require physical structures and equipment that are expensive to install and maintain. AES are also limited to registering a few types of violations, i.e. red light and speed violations. The major criteria to deploy AES is profitability for the supplier of the technology, thus, they are not used in areas where their cost is higher than the revenue originated. The use of such technology encounters resistance in society where it is regarded by some as means for the government and private parties to mainly generate income.

Common citizens are not used to record and report traffic violations. Today, only police officers and Automated Enforcement Systems are used to register a traffic violation.

Traffic enforcement authorities do not have a method or a set of procedures in place to receive and process information from a common citizen regarding the occurrence of a traffic violation.

Common citizens do not have a method or a system or a well established way in place to register and report the occurrence of a traffic violation.

An increase in enforcement by registering and collecting the traffic violations that today go unaccounted for would 1) inhibit transgressions by careless and negligent drivers, 2) make traffic flow better, 3) reduce traffic accidents, 4) save lives, 5) save money in health care and property damage costs, 6) increase the revenue of government agencies.

Therefore, a need exists for a new method and system to identify and register the occurrence of traffic violations that occur where and when either police officers and Automated Enforcement Systems are not present and consequentially to have a traffic ticket or a notice of citation issued that is inexpensive for the traffic enforcement authority to implement, that provides increased enforcement, that expands the area of enforcement, that is capable to register several types of violations and that is better accepted by society.

### BRIEF SUMMARY

This invention is an innovative method that enables common citizens as agents to record and report the occurrence of traffic violations in a well established and easy to use process, and more specifically to a method and system for a common citizen to record the occurrence of a traffic violation and report this information to the proper agent responsible to issue a traffic citation and/or to a method and system for a traffic enforcement authority or agent to use common citizens to identify and record the occurrence of traffic violations and to receive said information to produce a traffic citation.

In the prior art, the method to capture a traffic violation uses either a police officer as the agent or Automated Enforcement Systems (AES). The concept of using the common citizen as an agent to record traffic violations is not obvious and does not exist today.

By using a common citizen to capture traffic violations, the traffic enforcement authority does not have to incur in expenses to hire, train and equip an agent. The traffic enforcement authority also does not have to invest in AES.

The enforcement area is expanded as common citizens drive everywhere at anytime. Enforcement is achieved on a statistical basis. Not all citizens will become agents to record traffic violations. A traffic violation will be captured when the probability of occurrence of a traffic violation in a given place at a given time meets the probability of a common citizen who also acts as an agent to record traffic violations to be present at the same location at the same time. Revenue will be generated when the respective fines are collected. Nonetheless, transgression will be inhibited everywhere and at all times because negligent drivers will never know for sure if a citizen who is also a recording agent is present or not.

Society will greatly benefit as drivers will be more careful to obey traffic laws and traffic will flow in a more orderly way. Consequently, there will be a reduction in traffic accidents, reduction of time spent in traffic, reduction of losses of lives and property. Society will also save in health care costs and benefit from an increase in productivity. As enforcement is increased and expanded, more traffic violations will be registered and more citations will be issued.

The method to register traffic violations using a common citizen comprises of:
1) A common citizen using an electronic apparatus to register the occurrence of traffic violations.
2) A means to transmit the information of the said traffic violation to a processing agent.
3) A means to validate the occurrence of the said traffic violation.
4) A means to issue a citation or a notice of citation for the said traffic violation.

### DETAILED DESCRIPTION

The terminology used herein is for the purpose of describing particular embodiments only and is not intended to be limiting of the invention. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exemplification of the invention, and is not intended to limit the invention to specific embodiments.

Embodiments herein describe a method to identify and register traffic violations using a common citizen to generate a traffic citation or notice of citation.

According to an embodiment a common citizen will register himself as a participating agent in the system. The purpose of registration is to validate the submissions of traffic violations in good faith. Once registered, the participating citizen will become a user of the system.

The participating citizen (now on simply referred as user) will use an electronic apparatus to register the occurrence of traffic violations. The said electronic apparatus will comprise of a camera to record traffic violations. The common use of system will be of a camera installed in the dashboard of the user's car, who, while driving, will observe the behavior of other drivers. The camera once turned on will record in loop mode. When a violation is observed, the user will command the camera to register the occurrence of the violation. The camera will automatically save a file in its memory comprising of a time interval beginning 2 minutes prior the actuation of the button and ending 2 minutes after. Said time interval can be modified by the user to make sure the violation is properly captured and the license plate of the transgressor is registered. The recording apparatus will geotag the location and time of the footage. The generated computer file will be saved for submission at a convenient time.

The recording apparatus will operate in conjunction with a cell phone app or with a desktop computer software where the user will be able to review the footage of the traffic violation and choose if and when to submit the information. He may choose, for example, to transmit the information at a later time, from home.

A process to validate the occurrence of the said traffic violation takes place after the information is received either by a processing third party or by the traffic enforcement authority. The process of validation comprises of identifying the license plate of the transgressor and the violation type. Furthermore, this information will be compared to the traffic rules established for the location and time of the occurrence to confirm a violation actually occurred. This process will have to be performed or supervised or reviewed by a police officer if local ordinances mandate so.

Once validated, the information will be used to issue a citation or a notice of violation and the owner of the vehicle will be notified to pay the appropriate fine. The owner of the vehicle will be able to verify the footage of the occurrence over the internet in a dedicated website or dedicated app.

Various embodiments may include variations where the common citizen participating in the program is rewarded with a percentage of the proceeds, a fixed amount per citation or by a fixed monthly stipend. Various embodiments may include variations where the recording apparatus to record the traffic violation may include sensors and other measuring devices such as speed radars to register the speed of vehicles. Various embodiments may include variations where the recording apparatus to record the traffic violation consists of several cameras aiming at different angles. Various embodiments may include variations where the recording apparatus to record the traffic violation can be a personal handheld device such as a smart phone or a tablet. In various embodiments, the recording apparatus can be the only apparatus needed by the common citizen to register the violation. In various embodiments, the recording apparatus can operate automatically without the common citizen input by using an Artificial Intelligence algorithm to identify and record the traffic violation and/or transmit the information to an agent for processing. In various embodiments, the recording apparatus can use different input commands to record the traffic violation, i.e. voice or gesture. Various embodiments may include a way to tamper proof the file containing the footage. Various embodiments may include variations where the recording apparatus to record the traffic violation is fitted with a way or means to transmit the information of the recorded violation to a server. Various embodiments may include variations where the recording apparatus to record the traffic violation automatically transmits the information of the recorded violation to a server. Various embodiments may include variations where the recording apparatus to record the traffic violation can be installed on a motorcycle, bicycle or even be used handheld. Various embodiments may include variations where the recording apparatus to record the traffic violation can be installed in a fixed location. Various embodiments may include variations where the common citizen participating in the program is not required to register to participate. Various embodiments may include variations where the common citizen participating in the program is provided a way to input the license plate of the transgressor. Various embodiments may include variations where the common citizen participating in the program goes through a background check before being approved.

The present invention is advantageous over existing art as it increases and expands enforcement presence without the need to hire and train more police officers to record traffic violations. The present invention also does not require the purchase, lease, installation or maintenance of automated enforcement systems. The present invention also records a various types of traffic violations. The present invention engages the community in traffic enforcement.

What is claimed is:

1. A method to register a traffic violation using a common citizen (user) and comprising the steps of:
a) An electronic apparatus operated by a common citizen (user), recording a video in loop mode, responds to a request by the user and saves a file starting x minutes before the request is made and ending x minutes after the request is made.
b) The user transmits the file to a processing agent for validation. The validation process will verify if the file contains evidence of the occurrence of a traffic violation and if the transgressor is identifiable.
c) A citation or notice of citation is issued based on the information received.

2. The method of claim 1, further comprising the use of an electronic apparatus or computer software to verify the speed of a moving vehicle.

3. The method of claim 1, further comprising the use of an electronic apparatus operated by a common citizen (user) capable of identifying the occurrence of a traffic violation using an artificial intelligence algorithm and recording said violation.
